(19) United States
(12) Patent Application Publication
(10) Pub. No.: US 2018/0060945 A1
(43) Pub. Date: Mar. 1, 2018

(54) Method and device providing for interactive connectivity between a user and online resources

(71) Applicant: Rick Hammond, Alpharetta, GA (US)

(72) Inventor: Rick Hammond, Alpharetta, GA (US)

(21) Appl. No.: 15/731,925

(22) Filed: Aug. 23, 2017

Related U.S. Application Data
(60) Provisional application No. 62/378,427, filed on Aug. 23, 2016.

(51) Int. Cl. G06Q 30/06

(52) U.S. Cl. CPC G06Q 30/0641; H04N 21/2187

(57) ABSTRACT

A first device having a processor, a display, a data transmitter, and a data receiver. The first device processor is operable to process data received through the data receiver from a data transmitter on a second, remote device, and display it on the first device display. The first device processor is operable to process data input to it by a user, and transmit that data to a data receiver on a second, remote device. Further, the first device processor is operable to process data received from a data transmitter on a second remote device and display it on the first device display. The first device processor is operable to display video data generated in and received by the first device from a second, remote device. The first device processor is operable to generate data and transmit it to a second, remote device for display on a display provided on the second, remote device.

The present invention relates to the field of mobile means for providing communication between a user, on one hand, and a crowd funding resource, an auction resource, and/or a marketplace resource.

In one sense, the invention provides for mobile participation in a live video streaming auction, a crowd funding resource, and/or a marketplace application.

### SUMMARY OF THE INVENTION

A camera on a seller's remote device may be provided to make the system operable to transmit live stream video from a third party source, and format the video so that it is displayed on a user's device in a live auction format, or in a crowd funding format for promotion via the system, by the third party, of an item for purchase either directly or by way of an auction format. The system provides means by which the third party may collect funds during the live stream or thereafter.

Users wishing to buy an item can communicate with a seller, live, to ask questions or make offers to the seller in real time in the form of bids. Sellers can also choose to skip the auction option instead choosing to sell items for a fixed price by using a SELL NOW feature. When doing this, the video stream can be stored on a server for prospective buyers to view at their leisure, completely bypassing the auction format.

Users wishing to donate to crowd funding campaigns can communicate live with the promoter and ask questions of the promoter in real time, and make donations through the system. Promoters can be promoting any project they wish. For example, a singer/songwriter can sing a song then ask for donations/pay during the first few minutes with the option to terminate the live broadcast by timer if payment not received during the pay period allowed during the broadcast.

### BRIEF DESCRIPTION OF THE DRAWINGS

FIG. 1 is a flow chart outlining steps in a method for using the invention;

FIG. 2 is screen shot of a processor device;

FIG. 3 is screen shot of a processor device;

FIG. 4 is screen shot of a processor device;

FIG. 5 is a diagram showing steps in a method for using the invention;

FIG. 6 is screen shot of a processor device;

FIG. 7 is screen shot of a processor device;

FIG. 8 is a screen shot showing a message that might be displayed in a step in a method for using the invention;

FIG. 9 is screen shot of a processor device; and

FIG. 10 is screen shot of a processor device.

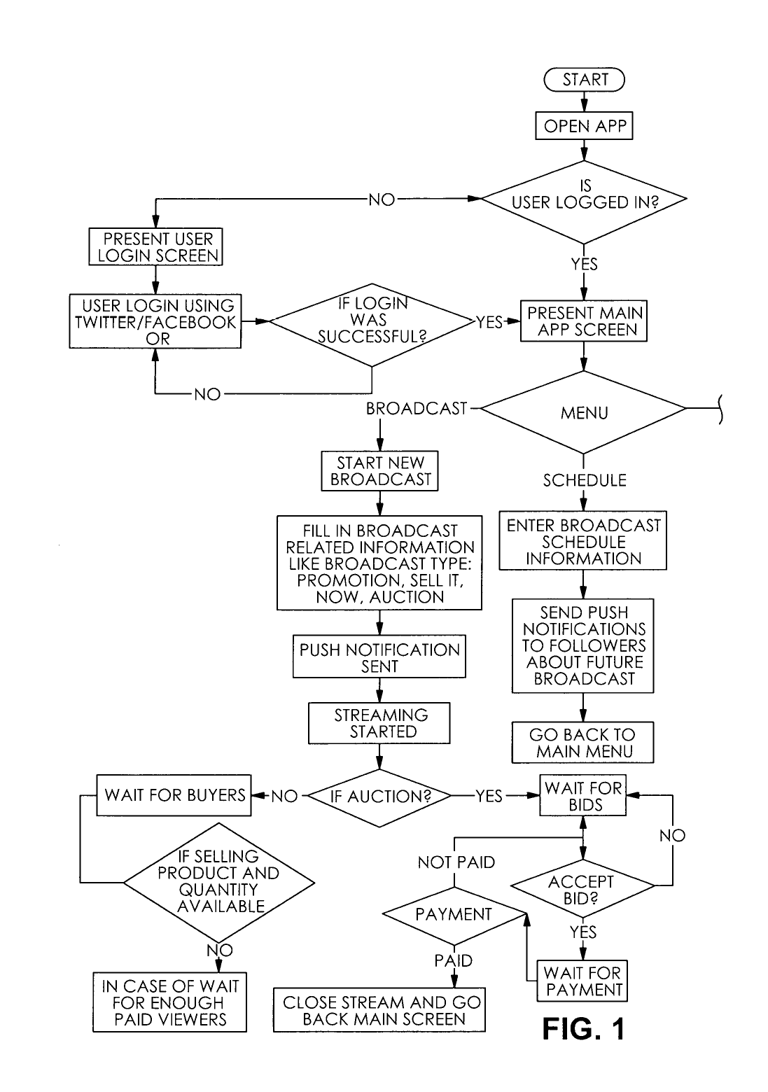

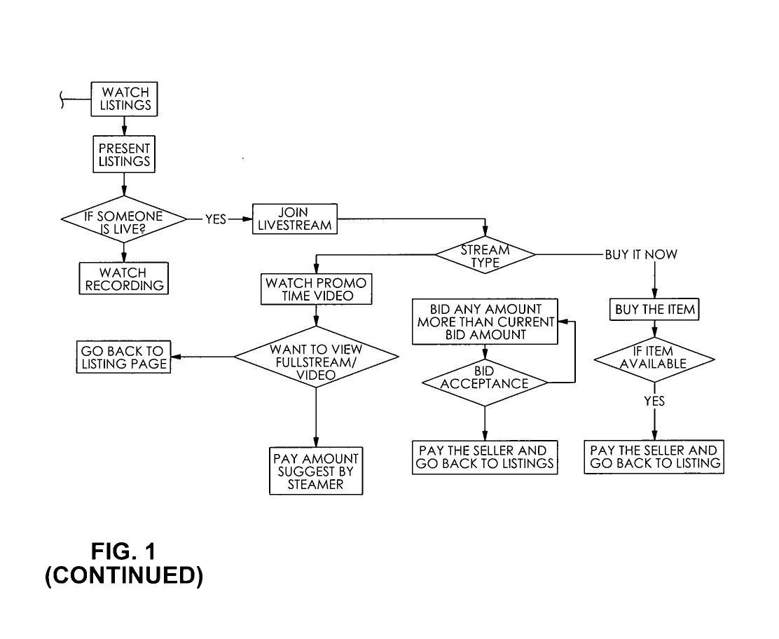

### DESCRIPTION OF THE PREFERRED EMBODIMENTS

The invention is a first device with a processor and a display, and a method for using it. The processor is operable to handle a video stream generated in a second remote device and display it on the screen of the first device.

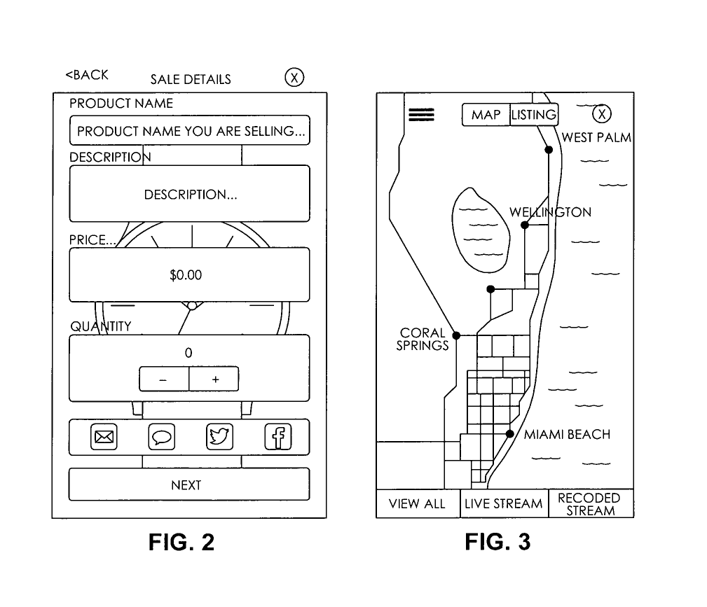

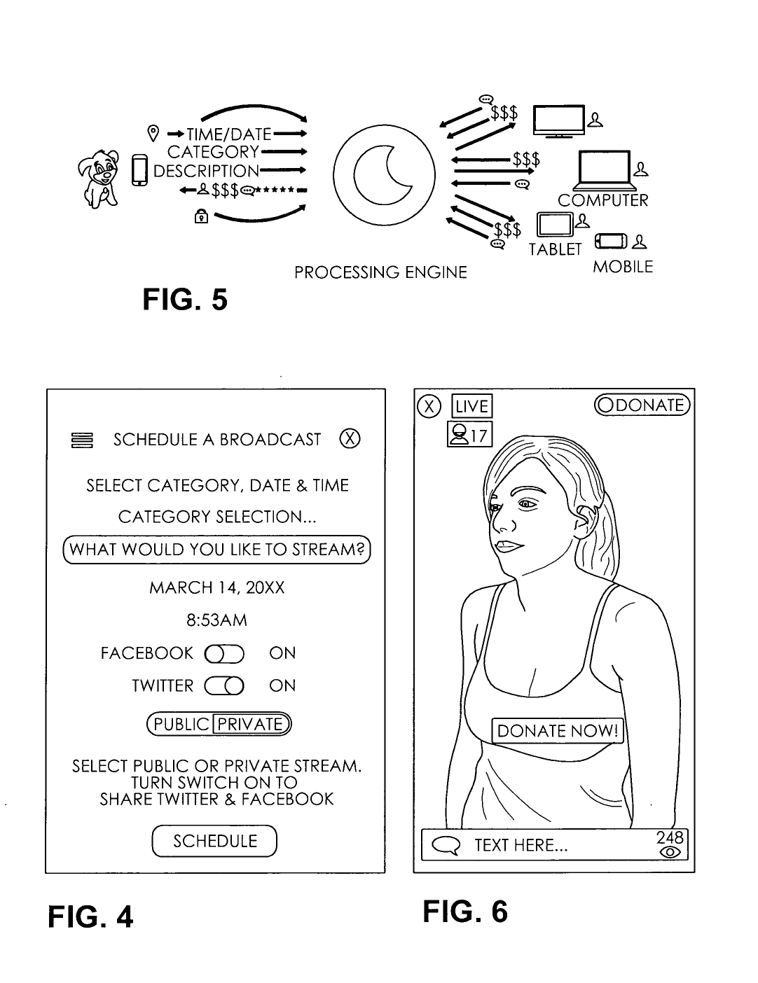

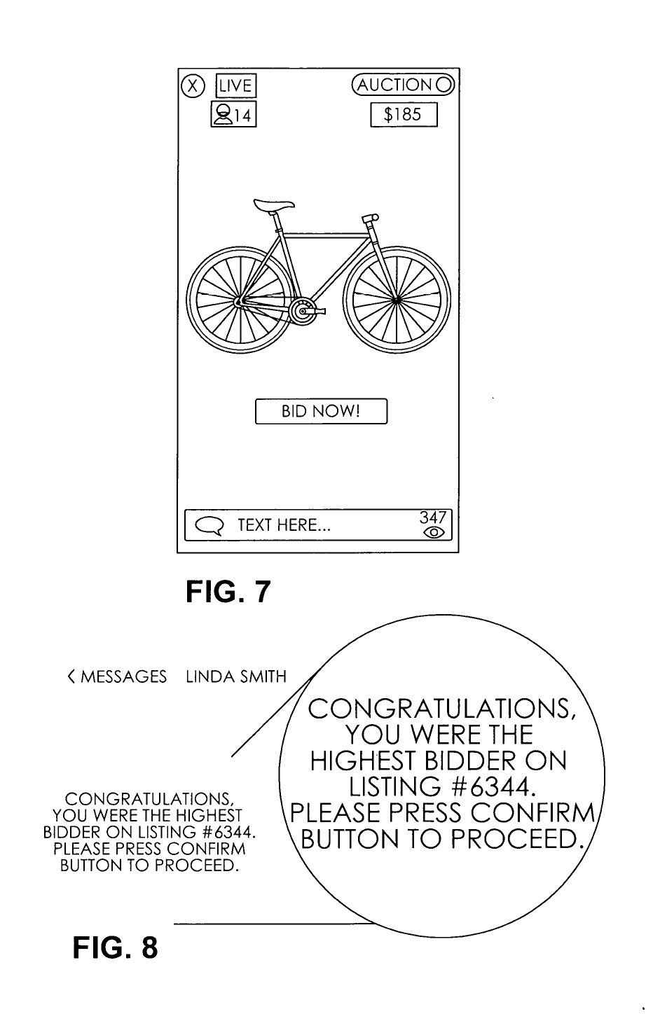

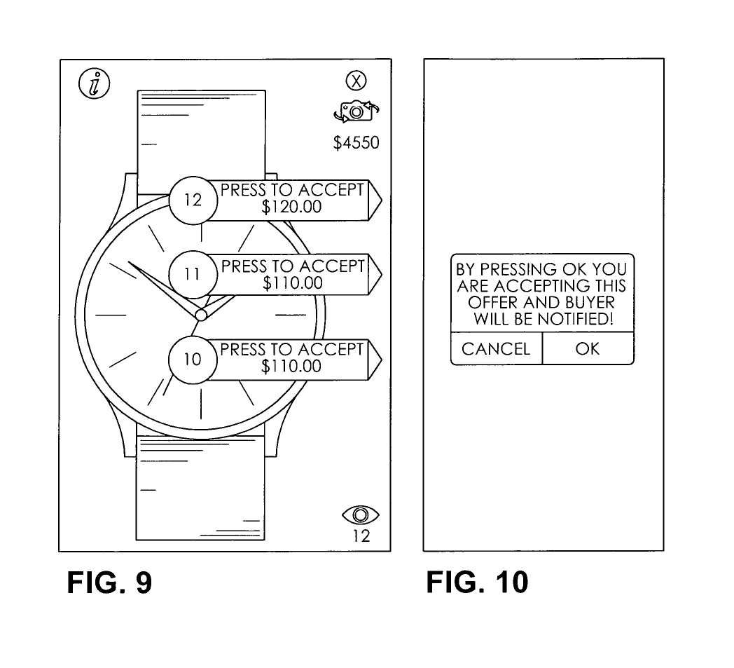

The video streaming may be handled by a third party plugin in the first device that transcodes video from the mobile device and relays it to a server. The server then formats the transcoded video and displays it within the application for a user by generating a GUI in real-time. The video and GUI are part of an auction room or a crowd funding promotion campaign run by promoters. An auction room display on the first device is shown in FIG. 2.

Users can browse different auction rooms or promoters by region or category with them displayed as an overlay on a map within the application, as shown in FIG. 3. Users may join the auction room or the promotion site whenever they would like to, on the fly. One exception would be a case where there is a live auction or a live promotion by a promoter because, in the case of one of these exceptions, the event has a closing time when bidding/donating is over. Users may join at any point before closing time.

### Auction Rooms are Handled as Follows:

Once inside an auction room, users can communicate with the seller in real time using a chat overlay on the first device. Users can also submit bids by using a “Bid Now” option on the first device. A bid must be more than a previous bid as in a typical auction format. A seller can decide at any point to select the highest bid and end the auction at or before an auction closing time set by the seller.

After an auction has ended, the winning bidder may be required to pay within a preset period of time—48 hours, for example—using a pre-defined payment option that is acceptable to the seller or promoter, such as PayPal). PayPal would handle all disputes and transactions between the auctioneer and the user. Other payment mechanisms may be used in place of PayPal. The seller then ships the item to the buyer's address listed on the transaction details.

There is also a rating system provided in the processor of the first device which provides a buyer or a user with means by which they can input data constituting a rating of the seller or promoter, and vice versa. At the conclusion of each transaction, the buyer and seller both can rate one another via, for example, a five-star system. The system can display a rating in an auction overlay view on the second, remote device to make it easier for prospective buyers to ensure they get what they pay for. Sellers also see the buyer's rating when they bid and can choose to reject a bid if the bidder's rating isn't high enough or has too many negative reviews.

### Promoters and Promotions are Handled as Follows:

Once the first device is connected to the second remote device, the user of the first device will be virtually inside a promoter's room. The first and second devices make it possible for users to interact with the promoters to learn more about a specific project or offering. The first and second devices may include a chat overlay feature to enable the promoter and the user of the first device to chat in real-time. At some point in time, the promoter can ask for donations. If a user does not agree to donate within a given time from a closing time set by the promoter, the first and second devices may provide means by which the user will be disconnected from the promoter's room. Donations may be handled via a pre-defined acceptable payment option such as PayPal. Other payment mechanisms may be used in place of PayPal. The promoter can set a minimum donation amount which will be transmitted from the second device to the first device where it will be displayed. Promoters also may have reviews attached to them, but the reviews are separate from the auction reviews.

I claim:

1. A first device having a processor, a display, a data transmitter, and a data receiver,
wherein said first device processor is operable to process data received through the data receiver from a data transmitter on a second, remote device, and display it on the first device display,
wherein said first device processor is operable to process data input to it by a user and transmit that data to a data receiver on a second, remote device,
wherein said first device processor is operable to process data received from a data transmitter on a second remote device and display it on the first device display,
wherein said first device processor is operable to display video data generated in and received by the first device from a second, remote device, and
wherein said first device processor is operable to generate data and transmit it to a second, remote device for display on a display provided on the second, remote device.
